(19) United States
(12) Patent Application Publication
(10) Pub. No.: US 2013/0214889 A1
(43) Pub. Date: Aug. 22, 2013

(54) MULTILAYER TYPE INDUCTOR AND METHOD OF MANUFACTURING THE SAME

(71) Applicant: SAMSUNG ELECTRO-MECHANICS CO., LTD., (US)

(72) Inventors: Myeong Gi KIM, Anyang-si (KR); Sung Yong AN, Anyang-si (KR)

(73) Assignee: SAMSUNG ELECTRO-MECHANICS CO., LTD., Suwon (KR)

(21) Appl. No.: 13/765,207

(22) Filed: Feb. 12, 2013

(30) Foreign Application Priority Data
Feb. 21, 2012 (KR) 10-2012-0017510

(51) Int. Cl. H01F 41/00; H01F 27/28; H01F 27/29

(52) U.S. Cl. CPC H01F 41/00; H01F 27/292; H01F 27/2804
USPC 336/192; 29/602.1

(57) ABSTRACT

Disclosed herein are a multilayer type inductor and a method of manufacturing the same. The multilayer type inductor includes a multilayer body in which a plurality of sheets having internal electrodes formed thereon are bonded to each other, and each of the internal electrodes is connected to each other through a via to form a coil; and a pair of external electrode terminals each formed at the both ends of the multilayer body and connected to one ends of the internal electrodes at the uppermost layer and the lowermost layer, wherein in the plurality of the sheets configuring the multilayer body, a first sheet and a second sheet made of different materials are alternately multi-layered, thereby increasing reliability and productivity of the product.

### CROSS REFERENCE(S) TO RELATED APPLICATIONS

This application claims the benefit under 35 U.S.C. Section 119 of Korean Patent Application Serial No. 10-2012-0017510, entitled “Multilayer Type Inductor And Method Of Manufacturing The Same” filed on Feb. 21, 2012, which is hereby incorporated by reference in its entirety into this application.

### BACKGROUND OF THE INVENTION

1. Technical Field

The present invention relates to a multilayer type inductor and a method of manufacturing the same, and more particularly, to a multilayer type inductor in which sheets made of different materials are alternately multilayered, and a method of manufacturing the same.

2. Description of the Related Art

An inductor, which is one of the main passive elements configuring, together with a resistor and a capacitor, an electronic circuit, is used to remove noise or used as a component configuring an LC resonance circuit. The inductor may be manufactured by winding a coil around a ferrite core or performing printing and forming electrodes at both ends thereof or be manufactured by printing an internal electrode on a magnetic layer or a dielectric layer and then multi-layering the magnetic layers or the dielectric layers.

The inductor may be classified into several types such as a multilayer type, a winding type, a thin film type, and the like, according to a structure thereof.

According to the related art, a winding type inductor manufactured by winding a conductive coil around the ferrite core, which is a magnetic material, has been mainly used. In the winding type inductor, since the ferrite core is manufactured by molding ferrite powders by a method such as a powder compression molding method, or the like, and then performing a firing process, it is difficult to mass produce the winding type inductor. In addition, since a completed product has a large size and volume, it may not be used in a small-sized electronic device.

Therefore, the multilayer type inductor has been widely used. Unlike the winding type inductor, the multilayer type inductor, which a high performance inductor having a small appearance and formed in a thin chip shape to thereby be appropriate for miniaturization and thinness of the electronic device, has been widely used as a power inductor configuring a power supply circuit, for example, a direct current (DC)-DC converter, of the electronic device.

The multilayer type inductor is manufactured in a multilayer body form in which a plurality of ceramic sheets (which are made of ferrite or low k-dielectric) are multi-layered. Coil type metal patterns are formed on ceramic sheets. The Coil type metal patterns formed on the respective ceramic sheets are sequentially connected to each other through conductive vias formed in the respective ceramic sheets, and overlapped in a multi-layering direction to form a coil having a spiral structure. Both ends of the coil are exposed to an external surface of the multilayer body to thereby be connected to an external terminal.

Meanwhile, in a general power inductor, when current applied to a coil (inductor) increases, magnetic force also increases. However, when the general power inductor is in a magnetic saturation state in which magnetic flux density no longer increase, nor does the magnetic force increase. When the power inductor is in the magnetic saturation state, even though strength (H) of a magnetic field increases, the magnetic flux density (B) hardly increases. Therefore, permeability (B/H) decreases, such that inductance also rapidly decreases. When the power inductor is in the magnetic saturation state, the inductance rapidly decreases and heat is significantly generated. Generally, at the time of the magnetic saturation, a temperature is about 120° to 150°, which is called a Curie point. At this temperature, the permeability rapidly decreases.

In general, the multilayer type inductor is magnetically saturated at current lower than that of the winding type inductor. That is, ferrite oxides mainly used as a magnetic material of the multilayer type inductor has high permeability and electrical resistance, but has low saturation magnetic flux density, such that a rapid decrease in inductance (that is, a decrease in DC overlapping characteristics) is generated due to the magnetic saturation.

Therefore, research into a technology of preventing the rapid decrease in inductance, that is, the decrease in DC overlapping characteristics has been currently conducted variously.

In connection with this, a multilayer type power inductor formed by multi-layering non-magnetic layers between a plurality of magnetic layers has been suggested in Korean Patent Laid-Open Publication No. 10-2010-0129580 (hereinafter, referred to as a related art document). That is, a separate non-magnetic layer is inserted as a gap between the magnetic layers to cut the magnetic flux in order to secure DC overlapping characteristics.

However, in this case, due to a difference in a sintering coefficient between non-magnetic layer used as the gap and the magnetic layer made of ferrite, a distortion phenomenon between the non-magnetic layer and the magnetic material layer may occur during a sintering process after multi-layering, which leads to a product defect.

In addition, the manufactured multilayer type inductor should be appropriate for an inductance specification and an electrical resistance specification defined in product specifications, and a size of the multilayer type inductor should also satisfy a specification defined in the product specifications. However, in a multilayer type inductor mass-produced so as to have a final product thickness of 1 mm or less, this thickness of the non-magnetic layer can not but be a limitation in mass-producing the multilayer type inductor.

### RELATED ART DOCUMENT

### Patent Document

(Patent Document 1) Korean Patent Laid-Open Publication No. 10-2010-0129580

### SUMMARY OF THE INVENTION

An object of the present invention is to provide a multilayer type inductor in which sheets made of different materials are alternately multilayered, and a method of manufacturing the same.

According to an exemplary embodiment of the present invention, there is provided a multilayer type inductor including: a multilayer body in which a plurality of sheets having internal electrodes formed thereon are bonded to each other and each of the internal electrodes is connected to each other through a via to form a coil; and a pair of external electrode terminals each formed at the both ends of the multilayer body and connected to one ends of the internal electrodes at the uppermost layer and the lowermost layer, wherein in the plurality of sheets configuring the multilayer body, a first sheet and a second sheet made of different materials are alternately multi-layered.

The first sheet may be made of a ferrite material, and the second sheet is made of a metal magnetic material.

The metal magnetic material may be at least one material selected from a group consisting of iron (Fe), Fe—Si based alloy, Sendust (Fe—Si—Al), Permalloy (Fe—Ni), Fe—Si—Cr based alloy, and Fe—Si—B—Cr based amorphous alloy, or a mixture of at least two materials.

The multilayer type inductor may further include a cover layer provided on an upper surface and/or a lower surface of the multilayer body.

The internal electrode may be at least one material selected from a group consisting of silver (Ag), palladium (Pd), aluminum (Al), nickel (Ni), titanium (Ti), gold (Au), copper (Cu) and platinum (Pt), or a mixture of at least two materials.

According to another exemplary embodiment of the present invention, there is provided a method of manufacturing a multilayer type inductor, the method including: preparing a plurality of first and second green sheets made of different materials; forming internal electrodes and a via according to a predetermined pattern on one surfaces of the plurality of first and second green sheets, the via being formed at a predetermined position; alternately multi-layering the plurality of first and second green sheets; compressing and firing the plurality of multi-layered first and second green sheets; and forming a pair of external electrode terminals each connected one ends of the internal electrodes at the uppermost layer and the lowermost layer at both ends of the compressed and fired multilayer body.

The preparing of the plurality of first and second green sheets made of the different materials may include: preparing a slurry containing ferrite powders and a slurry containing metal magnetic powders, respectively; casting the respective slurries on a carrier film; and removing the carrier film.

The metal magnetic powder may be at least one material selected from a group consisting of iron (Fe), Fe—Si based alloy, Sendust (Fe—Si—Al), Permalloy (Fe—Ni), Fe—Si—Cr based alloy and Fe—Si—B—Cr based amorphous alloy, or a mixture of at least two materials.

The method may further include, after the compressing and firing of the plurality of multi-layered first the second green sheets, providing a cover layer on an upper surface and/or a lower surface of the multilayer body.

The internal electrode may be formed in a screen printing scheme.

### BRIEF DESCRIPTION OF THE DRAWINGS

FIG. 1 is an exploded perspective view of a multilayer type inductor according to an exemplary embodiment of the present invention;

FIG. 2 is a perspective view showing an outer portion of the multilayer type inductor according to the exemplary embodiment of the present invention;

FIG. 3 is a graph comparing saturation magnetization of a metal magnetic material and saturation magnetization of a ferrite material with each other;

FIG. 4 is a graph comparing changes in magnetic flux density of two materials of which saturation magnetizations are different with each other;

FIG. 5 is a graph comparing changes in inductance of two materials of which saturation magnetizations are different with each other;

FIG. 6 is a graph showing a change in inductance according to a frequency of the multilayer type inductor according to the exemplary embodiment of the present invention; and

FIG. 7 is a flow chart sequentially showing a method of manufacturing a multilayer type inductor according to the exemplary embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and an acting effect of exemplary embodiments of the present invention will be described in more detail with reference to the accompanying drawings.

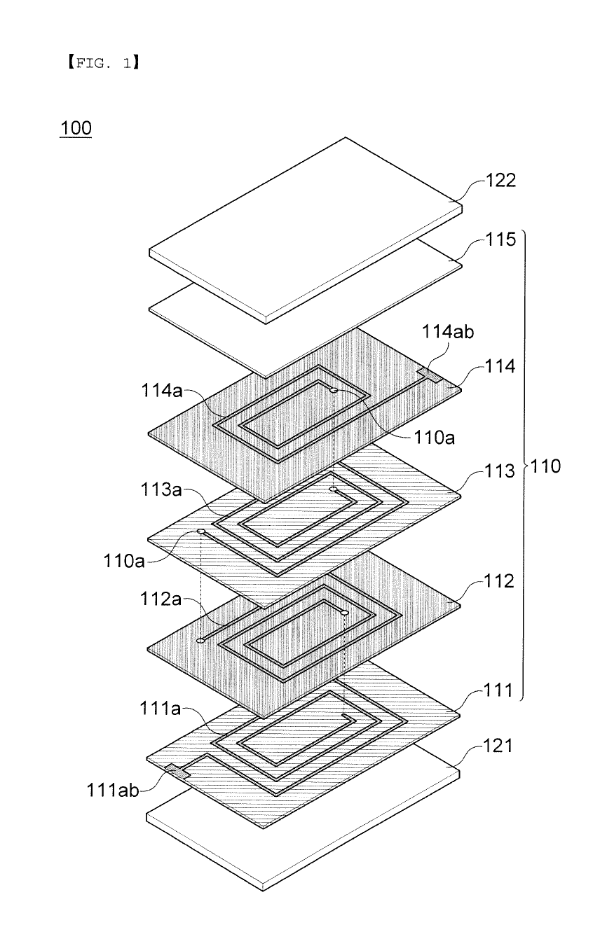

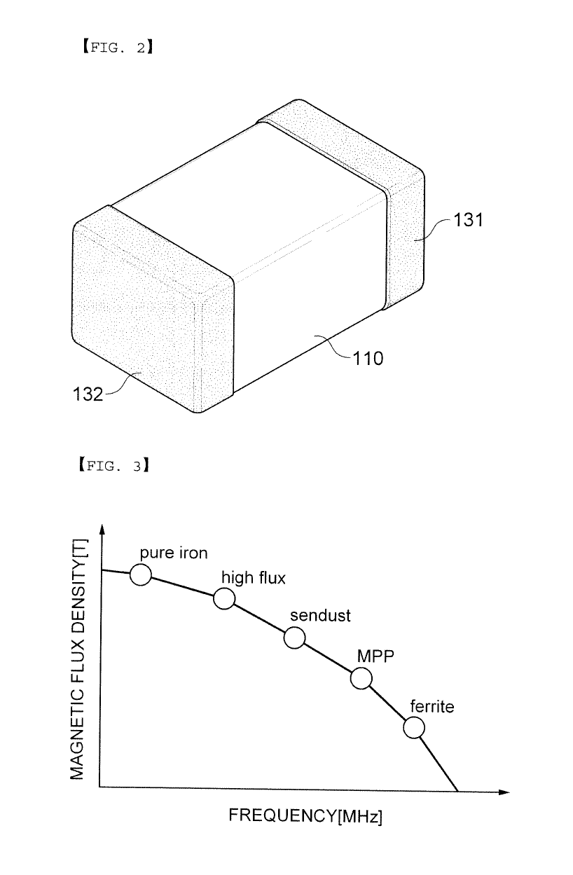

FIG. 1 is an exploded perspective view of a multilayer type inductor 100 according to an exemplary embodiment of the present invention, and FIG. 2 is a perspective view showing an outer portion of the multilayer type inductor 100 according to the exemplary embodiment of the present invention.

Referring to FIGS. 1 and 2, the multilayer type inductor 100 according to the exemplary embodiment of present invention may include a multilayer body 110 including a plurality of internal electrodes 111a, 112a, 113a, and 114a, and a pair of external electrode terminals 131 and 132 formed at both ends of the multilayer body 110.

The external electrode terminal 131 may be electrically connected to an electrode 114ab exposed from one end of the internal electrode 114a at the uppermost layer, and the external electrode terminal 132 may be electrically connected to an electrode 111ab exposed from one end of the internal electrode 111a at the lowermost layer. The internal electrodes 111a, 112a, 113a, and 114a may be electrically connected to external circuits through the pair of external electrode terminals 131 and 132.

The internal electrodes 111a, 112a, 113a, and 114a, which is a conductive pattern generating a magnetic field by conducting current therein when power is applied thereto, may be made of at least one material selected from a group consisting of silver (Ag), palladium (Pd), aluminum (Al), nickel (Ni), titanium (Ti), gold (Au), copper (Cu), and platinum (Pt) having excellent electrical conductivity, or a mixture of at least two materials.

Each of the internal electrodes 111a, 112a, 113a and 114a may be formed on one surfaces of sheets 111, 112, 113 and 114, and a plurality of the sheets 111, 112, 113 and 114 on which the internal electrodes 111a, 112a, 113a and 114a are formed is bonded to each other to form a single multilayer body 110.

In addition, since the internal electrode 114a formed on one surface of the sheet 114 positioned at the uppermost layer is exposed to the outside, an external sheet 115 may be additionally provided on an upper surface of the sheet 114 positioned at the uppermost layer.

The multilayer type inductor 100 according to the exemplary embodiment of the present invention may further include an upper cover layer 121 and a lower cover layer 122 provided on an upper surface and/or a lower surface of the multilayer body 110. Since the cover layers 121 and 122 protect the multilayer body 110 from the outside and at the same time, forms a magnetic loop, the cover layers 121 and 122 may be made of a ferrite material having high permeability.

Each of the sheets 111, 112, 113 and 114 on which each of the internal electrodes 111a, 112a, 113a and 114a is printed may include a via 110a formed at a predetermined position thereof, for example, one end thereof. The internal electrodes 111a, 112a, 113a and 114a formed in each of the sheets 111, 112, 113 and 114 are electrically connected to each other through the via 110a to form a single coil.

Specifically, the plurality of sheets 111, 112, 113 and 114 configuring the multilayer body 110 are multi-layered by alternately bonding the first sheets 111 and 113 and the second sheets 112 and 114 made of different materials to each other. That is, the second sheet 112 is bonded to an upper surface of the first sheet 111, the first sheet 113 is again bonded to an upper surface of the second sheet 112, and the second sheet 114 is again bonded to an upper surface of the first sheet 113.

Although FIG. 1 shows the multilayer body 110 in which the first sheets 111 and 113 and the second sheets 112 and 114 are alternately bonded to each other in pair, respectively, the numbers of first sheets 111 and 113 and second sheets 112 and 114 are not limited to a predetermined number, but may set to any number in consideration of an inductance value defined in a thickness of a finally completed inductor and product specifications.

Specifically describing materials of the first sheets 111 and 113, and the second sheets 112 and 114, the first sheets 111 and 113 may be made of a ferrite material, and the second sheets 112 and 114 may be made of a metal magnetic material.

Here, the metal magnetic material may be at least one material selected from a group consisting of iron (Fe), Fe—Si based alloy, Sendust (Fe—Si—Al), Permalloy (Fe—Ni), Fe—Si—Cr based alloy and Fe—Si—B—Cr based amorphous alloy, or a mixture of at least two materials.

The following Table 1 shows a saturation magnetization value (Ms) of the metal magnetic material, and FIG. 3 is a graph comparing saturation magnetization of the metal magnetic material and saturation magnetization of the ferrite material with each other.

TABLE 1

| | Saturation magnetization value |
|---|---|
| Kind of metal magnetic material | (Ms) (emu/g) |
| Iron (Fe) | 192 |
| Fe—Si based alloy | 172 |
| Sendust | 115 |
| Permalloy | 150 |
| Fe—Si—Cr based alloy | 180 |
| Fe—Si—B—Cr based amorphous alloy | 145 |

Referring to Table 1 and FIG. 3, it could be appreciated that the metal magnetic material generally has a saturation magnetization value (Ms) larger than that of the ferrite material.

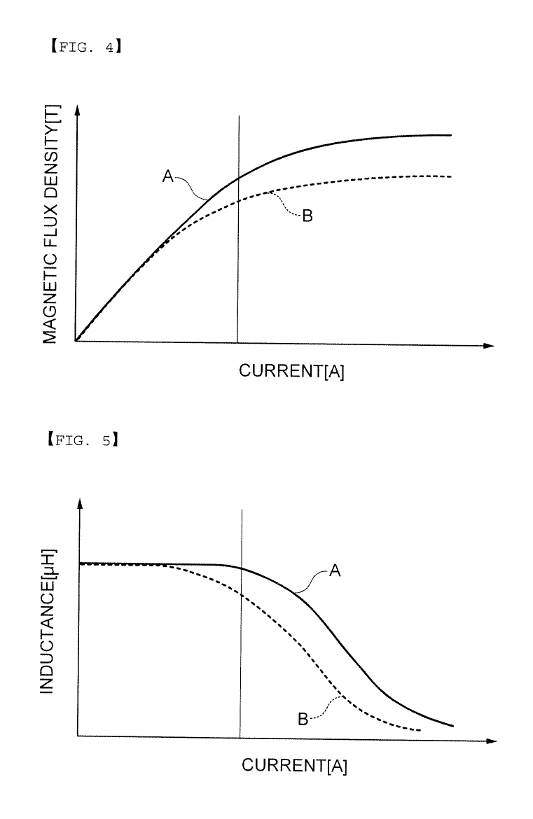

FIG. 4 is a graph comparing changes in magnetic flux density of two materials of which saturation magnetizations are different with each other, and FIG. 5 is a graph comparing changes in inductance of two materials of which saturation magnetizations are different with each other. Here, a curve A is a graph showing a material having a saturation magnetization value larger than that of a curve B.

As shown in FIG. 4, a change in magnetic flux density according to DC-bias in two materials having the same initial permeability is smaller in a material having a large saturation magnetization value (Ms) than in a material having a small saturation magnetization value (Ms). Accordingly, as shown in FIG. 5, a decrease in inductance according to the DC-bias is smaller in a material having a large saturation magnetization value (Ms) than in a material having a small saturation magnetization value (Ms).

According to the exemplary embodiment of the present invention, the first sheets 111 and 113 made of the ferrite material and the second sheets 112 and 114 made of the metal magnetic material are alternately multi-layered, such that magnetic saturation of the first sheets 111 and 113 made of the ferrite material is suppressed and insufficient permeability of the second sheets 112 and 114 made of the metal magnetic material may be supplemented with the first sheets 111 and 113 made of the ferrite material, thereby making it possible to secure the initial capacity of the inductor.

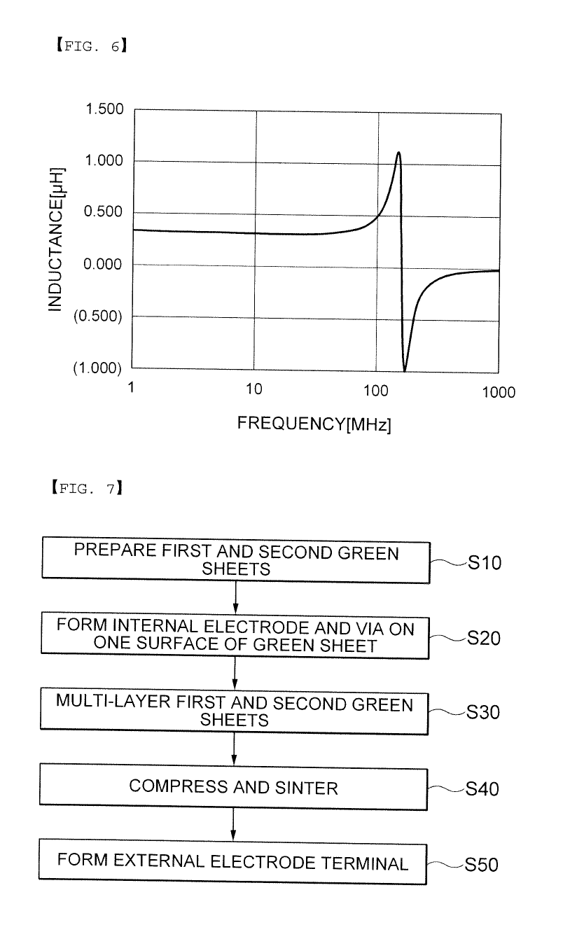

FIG. 6 is a graph showing a change in inductance according to a frequency of the multilayer type inductor 100 according to the exemplary embodiment of the present invention. Inductance was measured using an impedance analyzer in a frequency band of 1 KHz to 1 GHz.

In the case of the multilayer type inductor according to the related art formed of only sheets made of a ferrite material, inductance is significantly increased generally in 100 MHz at most. However, as shown in FIG. 6, in the case of the multilayer type inductor 100 according to the exemplary embodiment of the present invention, since inductance is increased in a frequency band exceeding 100 MHz, an allowed frequency (a switching frequency region allowed within 20% as compared to an initial value when a switching frequency is increased) is significantly increased.

Hereinafter, a method of manufacturing a multilayer type inductor 100 according to the exemplary embodiment of the present invention will be described. The final product completed according to the method of manufacturing the multilayer type inductor 100 according to the exemplary embodiment of the present invention is the multilayer type inductor 100 in FIGS. 1 and 2. Therefore, each of the following reference numerals is the reference numerals of FIGS. 1 and 2.

FIG. 7 is a flow chart sequentially showing a method of manufacturing a multilayer type inductor 100 according to the exemplary embodiment of the present invention.

Referring to FIG. 7, in the method of manufacturing a multilayer type inductor 100 according to the exemplary embodiment of the present invention firstly, a step of preparing a plurality of first and second green sheets 111, 112, 113, and 114 made of different materials is first performed (S10).

Specifically, in step (S10), a slurry containing ferrite powder and a slurry containing metal magnetic powder are first prepared, respectively. Here, a material of the metal magnetic power may be at least one material selected from a group consisting of iron (Fe), Fe—Si based alloy, Sendust (Fe—Si—Al), Permalloy (Fe—Ni), Fe—Si—Cr based alloy and Fe—Si—B—Cr based amorphous alloy, or a mixture of at least two materials.

Each slurry may be prepared by pulverizing and mixing raw materials such as the ferrite powder or the metal magnetic powder, a dielectric powder, a binder, a plasticizer, and the like, using a two-roll mill, a three-roll mill, a ball mill, a trom mill, a disperser, a kneader, a cokneader, a homogenizer, a blender, a uniaxial or biaxial extruder, or the like.

Each slurry prepared as described above is casted on a carrier film. According to the exemplary embodiment of the present invention, each slurry is applied to the carrier film in a doctor blade tape casing scheme. As the carrier film, a PET film may be used, and other materials may also be used.

After the first green sheets 111, 112, 113 and 114 and the second green sheets 111, 112, 113 and 114 having different materials are completed by applying each slurry to the carrier film, the carrier film is removed.

A step of forming internal electrodes 111a, 112a,113a, and 114a and a via 110a according to a predetermined pattern on one surfaces of the first and the second green sheets 111, 112, 113 and 114 from which the carrier film is removed is performed (S20).

The internal electrodes 111a, 112a, 113a, and 114a may be precisely formed on one surfaces of the first and the second green sheets 111, 112, 113, and 114 by a screen printing method.

The screen printing method is a method of printing a predetermined pattern by passing a conductive paste made of at least one material selected from a group consisting of silver (Ag), palladium (Pd), aluminum (Al), nickel (Ni), titanium (Ti), gold (Au), copper (Cu), and platinum (Pt), and a mixture of at least two materials through an upper portion of a screen mask on which a predetermined pattern is formed. The internal electrodes 111a, 112a, 113a, and 114a is not limited to being formed by the above-mentioned method, but may also be formed by various methods well-known in the art to which the present invention pertains.

Meanwhile, the via 110a may be formed at a predetermined position, for example, a portion at which one ends of the internal electrodes 111a, 112a, 113a, and 114a are positioned, using a laser punching, a mechanical punching, or the like, so that the internal electrodes 111a, 112a, 113a, and 114a formed on each of the sheets 111, 112, 113 and 114 may be connected to each other.

After the internal electrodes 111a, 112a, 113a, and 114a and the via 110a are formed on the plurality of first and second green sheets 111, 112, 113, and 114, a step of multi-layering the second sheet 112 on an upper surface of the first sheet 111, again multi-layering the first sheet 113 on an upper surface of the second sheet 112, and then again multi-layering the second sheet 114 on an upper surface of the first sheet 113 are performed (S30).

Next, a step of compressing and firing the plurality of multi-layered first and the second green sheets 111, 112, 113 and 114 are performed (S40).

The slurry used at the time of preparing the first and the second green sheets 111, 112, 113 and 114 contains organic materials for maintaining formability. Since these organic materials has an adverse effect on performance of the inductor, heat treatment is first preformed at a temperature between 350° and 500°, and is then co-fired at a temperature between 850° and 900° to form a multilayer body 110.

Meanwhile, the method of manufacturing a multilayer type inductor 100 according to the exemplary embodiment of the present invention may further include providing cover layers 121 and 122 on an upper surface and/or a lower surface of the multilayer body 110. Since the cover layers 121 and 122 protect the multilayer body 110 from the outside and at the same time, forms a magnetic loop, the cover layer 121 and 122 may be made of a ferrite material having high permeability and be manufactured by multi-layering several first green sheets 111, 112, 113 and 114 prepared in step (S10).

Finally, a step of forming an external electrode terminal 131 electrically connected to an electrode 114ab exposed from one end of an internal electrode 114a at the uppermost layer, and an external electrode terminal 132 electrically connected to an electrode 111ab exposed from one end of an internal electrode 111a at the lowermost layer in both ends of the compressed and sintered multilayer body 110 is performed (S50), such that the multilayer type inductor 100 according to the exemplary embodiment of the present invention may be completed.

As set forth above, with the multilayer type inductor and the method of manufacturing the same according to the exemplary embodiments of the present invention, the first sheet made of the ferrite material and the second sheet made of the metal magnetic material are alternately multi-layered, such that at the time of applying DC-bias, the magnetic saturation of the first sheet made of the ferrite material can be suppressed and the insufficient permeability of the second sheet made of the metal magnetic material can be supplemented with the first sheet made of the ferrite material, thereby making it possible to secure the initial capacity of the inductor.

In addition, unlike the inductor according to related art, since a non-magnetic layer for improving inductance are not provided, a distortion phenomenon between the non-magnetic layer and the magnetic layer due to a difference in a sintering coefficient between the non-magnetic layer and the magnetic layer at the time of manufacturing of the inductor is prevented, thereby making it possible to improve reliability of the product, and a required size of a product is not limited, thereby making it possible to increase productivity of the product.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A multilayer type inductor comprising:
a multilayer body in which a plurality of sheets having internal electrodes formed thereon are bonded to each other and each of the internal electrodes is connected to each other through a via to form a coil; and
a pair of external electrode terminals each formed at the both ends of the multilayer body and connected to one ends of the internal electrodes at the uppermost layer and the lowermost layer,
wherein in the plurality of sheets configuring the multilayer body, a first sheet and a second sheet made of different materials are alternately multi-layered.

2. The multilayer type inductor according to claim 1, wherein the first sheet is made of a ferrite material, and the second sheet is made of a metal magnetic material.

3. The multilayer type inductor according to claim 2, wherein the metal magnetic material is at least one material selected from a group consisting of iron (Fe), Fe—Si based alloy, Sendust (Fe—Si—Al), Permalloy (Fe—Ni), Fe—Si—Cr based alloy, and Fe—Si—B—Cr based amorphous alloy, or a mixture of at least two materials.

4. The multilayer type inductor according to claim 1, further comprising a cover layer provided on an upper surface and/or a lower surface of the multilayer body.

5. The multilayer type inductor according to claim 1, wherein the internal electrode is at least one material selected from a group consisting of silver (Ag), palladium (Pd), aluminum (Al), nickel (Ni), titanium (Ti), gold (Au), copper (Cu) and platinum (Pt), or a mixture of at least two materials.

6. A method of manufacturing a multilayer type inductor, the method comprising:
preparing a plurality of first and second green sheets made of different materials;
forming internal electrodes and a via according to a predetermined pattern on one surfaces of the plurality of first and second green sheets, the via being formed at a predetermined position;
alternately multi-layering the plurality of first and second green sheets;
compressing and firing the plurality of multi-layered first and second green sheets; and
forming a pair of external electrode terminals each connected one ends of the internal electrodes at the uppermost layer and the lowermost layer at both ends of the compressed and fired multilayer body.

7. The method according to claim 6, wherein the preparing of the plurality of first and second green sheets made of the different materials includes:
preparing a slurry containing ferrite powders and a slurry containing metal magnetic powders, respectively;
casting the respective slurries on a carrier film; and
removing the carrier film.

8. The method according to claim 7, wherein the metal magnetic powder is at least one material selected from a group consisting of iron (Fe), Fe—Si based alloy, Sendust (Fe—Si—Al), Permalloy (Fe—Ni), Fe—Si—Cr based alloy and Fe—Si—B—Cr based amorphous alloy, or a mixture of at least two materials.

9. The method according to claim 6, further comprising, after the compressing and firing of the plurality of multi-layered first and second green sheets, providing a cover layer on an upper surface and/or a lower surface of the multilayer body.

10. The method according to claim 6, wherein the internal electrode is formed in a screen printing scheme.
